(19) United States
(12) Patent Application Publication
(10) Pub. No.: US 2022/0176295 A1
(43) Pub. Date: Jun. 9, 2022

(54) FILTER ELEMENT WITH OUTLET PORT CHECK VALVE

(71) Applicant: Donaldson Company, Inc., Minneapolis, MN (US)

(72) Inventors: Daniel E. ADAMEK, Minneapolis, MN (US); Anthonius Jan-Baptist Maria MOERS, Minneapolis, MN (US)

(73) Assignee: Donaldson Company, Inc., Minneapolis, MN (US)

(21) Appl. No.: 17/604,915

(22) PCT Filed: Apr. 15, 2020
(86) PCT No.: PCT/US2020/028263

§ 371 Date: Oct. 19, 2021

Related U.S. Application Data
(60) Provisional application No. 62/836,437, filed on Apr. 19, 2019.

(51) Int. Cl. B01D 46/00; B01D 46/24; B01D 46/52

(52) U.S. Cl. CPC B01D 46/0089; B01D 2279/60; B01D 46/521; B01D 46/2414

(57) ABSTRACT

An air cleaner is includes a housing defining an interior cavity, the housing having an inlet, a first outlet, and a second outlet. The air cleaner also includes a filter cartridge with a media arrangement extending between first and second end caps. In one aspect, the first end cap defines a first opening to the interior volume of the media arrangement and the second end cap defines a second opening to the interior volume of the media arrangement. In one aspect, the first opening has a dimension that is less than half a corresponding dimension of the second opening. The air cleaner can also include a valve arrangement in fluid communication with the first opening that allows airflow through the first opening in a first direction from the interior volume to the exterior side and prevents airflow through the first opening in a second direction from the exterior side into the interior volume.

This application is being filed on Apr. 15, 2020, as an International PCT Application and claims the benefit priority to U.S. Provisional Patent Application Ser. No. 62/836,437, filed on Apr. 19, 2019, the entirety of which is incorporated by reference herein.

### TECHNICAL FIELD

The present invention relates to filter arrangements, typically for use in filtering air, such as intake air for internal combustion engines, and more particularly relates to filter assemblies that include multiple components arranged in a housing to provide desired filtering capabilities.

### BACKGROUND

Air or other gas filtering is desirable in a number of systems. A typical application is in the filtration of intake air to internal combustion engines. Another is in the filtration of crankcase ventilation filter assemblies. Typically, such systems comprise filter assemblies having a serviceable filter cartridge therein. After a period of use, filter media within a filter housing requires servicing, either through cleaning or complete replacement. Typically, for an air cleaner or crankcase ventilation filter assembly used with an internal combustion engine, for example, on a vehicle, the filter media is contained in a removable and replaceable, i.e. serviceable, component, typically referred as a filter element or cartridge. In some applications, the air cleaner provides filtered air to other systems associated with the internal combustion engine and/or a vehicle driven by the internal combustion engine.

### SUMMARY

An air cleaner is disclosed. The air cleaner can include a housing defining an interior cavity, the housing having an inlet, a first outlet, and a second outlet. The air cleaner also includes a filter cartridge. The air cleaner can also include a filter cartridge having a media arrangement defining an outer perimeter and an interior volume, and extending between a first end and a second end, the outer perimeter being in direct fluid communication with the housing inlet. The filter cartridge can also include a first end cap located proximate the media arrangement first end, the first end cap defining a first opening in fluid communication with the housing first outlet, and a second end cap located proximate the media arrangement second end, the second end cap defining a second opening generally circumscribed by a seal member forming a seal with the second outlet. In one aspect, the first opening has a dimension that is less than half a corresponding dimension of the second opening. The air cleaner can also include a valve arrangement in fluid communication with the first opening and the housing first outlet, the valve arrangement allows airflow through the first opening in a first direction from the interior volume to the exterior side and prevents airflow through the first opening in a second direction from the exterior side into the interior volume. In some examples, the valve arrangement is formed as part of the filter cartridge.

In some examples, the valve arrangement is a check valve biased into a closed position.

In some examples, the valve arrangement includes a deflectable stop member that deflects to allow airflow to flow in the first direction.

In some examples, the valve arrangement is in fluid communication with an internal passageway of a main body extending through the first opening.

In some examples, the valve arrangement is disposed within the internal passageway.

In some examples, the main body extends through the housing first outlet.

### BRIEF DESCRIPTION OF THE DRAWINGS

The present invention will be further explained with reference to the appended Figures, wherein like structure is referred to by like numerals throughout the several views, and wherein;

FIG. 1 is a side view of an system within which an air cleaner having features in accordance with the present disclosure is utilized.

FIG. 2 is a cross-sectional side view of the air cleaner shown in FIG. 1.

FIG. 3 is a cross-sectional side view of a filter cartridge of the air cleaner shown in FIG. 2.

FIG. 4 shows a schematic cross-sectional side view of a first example of an outlet arrangement of the filter cartridge shown in FIG. 3.

FIG. 5 shows a schematic cross-sectional side view of second example of an outlet arrangement of the filter cartridge shown in FIG. 3.

FIG. 6 shows a schematic cross-sectional side view of a third example of an outlet arrangement of the filter cartridge shown in FIG. 3.

### DETAILED DESCRIPTION

Herein, example filter assemblies, filter cartridges, features and components therefor are described and depicted. A variety of specific features and components are characterized in detail. Many can be applied to provide advantage. There is no specific requirement that the various individual features and components be applied in an overall assembly with all of the features and characteristics described, however, in order to provide for some benefit in accord with the present disclosure.

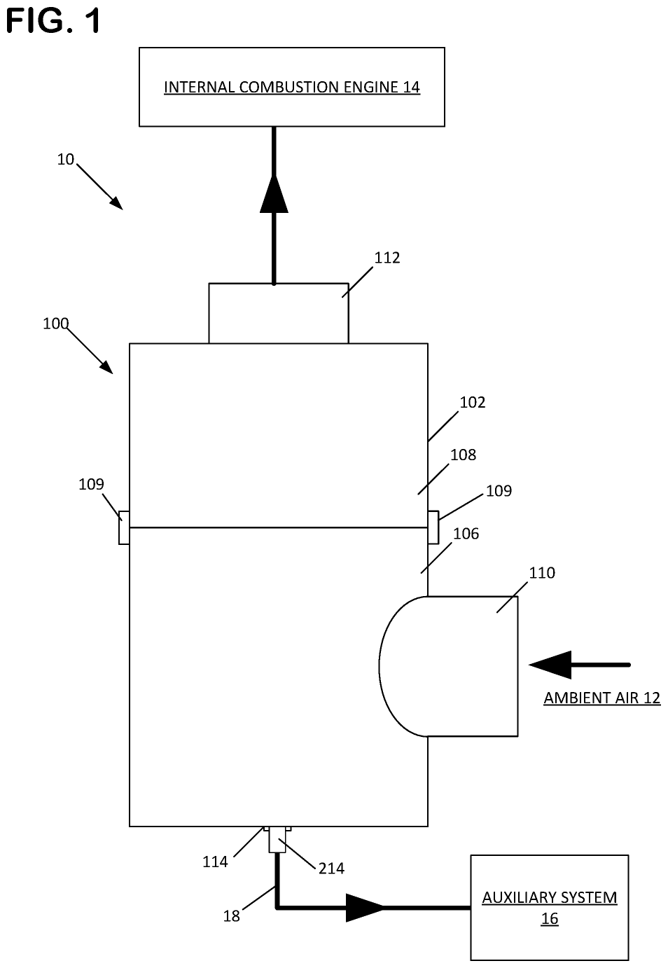

Referring to FIG. 1, a system 10 including an air cleaner assembly 100 is shown. In one aspect, the air cleaner assembly receives and filters ambient air 12 to provide clean, filtered air to the air intake of an internal combustion engine 14 and to an auxiliary system 16 that uses or requires a clean air source. In one example, the auxiliary system 16 is a compressed air system 16. In one aspect, the air cleaner assembly 100 includes a housing 102 defining an interior cavity 104. The housing 102 can be configured as a main housing 106 and a cover 108 that allow for the interior cavity 104 to be accessed when the cover 108 is removed from the housing 106. The cover 108 can be secured to the housing 106 with connectors 109 using any number of methods or approaches known in the art, for example by over-center latches, interacting lugs, and the like. In one aspect, the housing 102 includes an inlet 110 for accepting raw, untreated air 12, a first outlet 112 for discharging clean, filtered air to the intake of the internal combustion engine 14, and a second outlet 114 for discharging clean, filtered air to an ancillary system, such as a compressed air system 16.

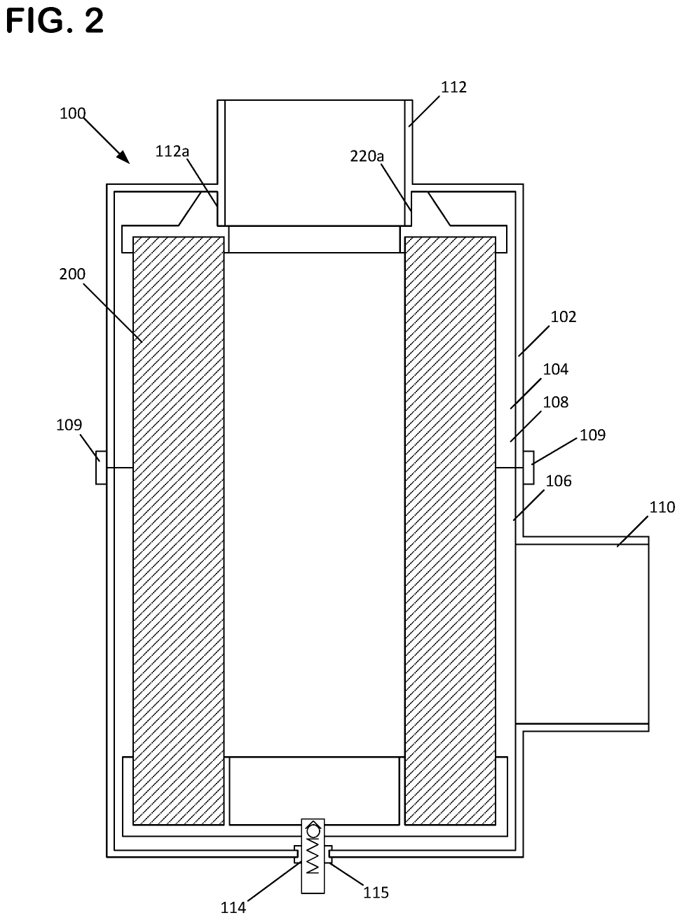

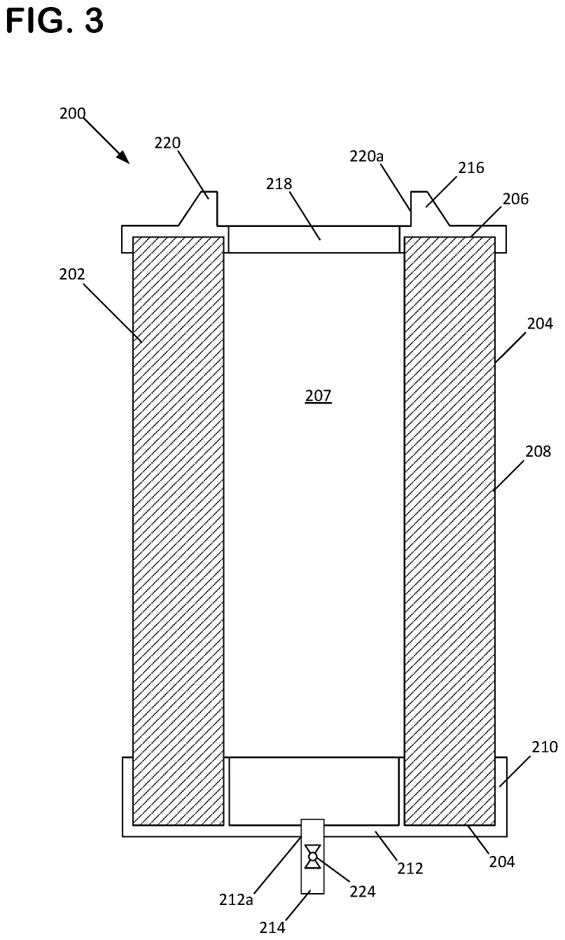

Referring to FIG. 2, a filter cartridge 200 is shown within the internal cavity 104 of the housing 102. The filter cartridge 200 converts the unfiltered air received at the inlet 110 to the clean, filtered air delivered to the outlets 112 and 114. In a typical arrangement, the filter cartridge 200 is removably positioned within the air cleaner assembly interior cavity 104, and would typically be considered to be a service component that is removable and replaceable, as desired and/or necessary. In one aspect, and as most easily seen at FIG. 3, the first filter cartridge 200 includes a media arrangement 202 having an exterior side 204 for receiving air from the inlet 110 and an interior passageway or volume 207 for delivering filtered air to the outlets 112 and 114. In the example shown, the media arrangement 202 is tubular with a hollow interior and has a round cross-sectional shape. However, other shapes are possible, such as obround, oval, and rectangular cross-sectional shapes. In one aspect, the media pack 202 defines an outer perimeter 208 extending between a first end 204 and a second end 206. In the example shown, the media arrangement 202 is formed from a pleated media construction. Suitable media constructions for the media arrangement 202 are discussed in more detail in the Media Types and Configurations section.

In one aspect, the filter cartridge includes a first end cap 210 positioned at the first end 204 of the media arrangement 202. As configured, the first end cap 210 includes an end wall 212 that closes the first end 204 of the media arrangement 202 and also closes the interior volume 207. The first end cap 210 is also shown as defining a port or opening 212a within the end wall 212 for receiving or defining an outlet arrangement 214, discussed later. The filter cartridge 200 can also include a second end cap 216 positioned at the second end 206 of the media arrangement 202. As configured, the second end cap 216 closes the second end 206 of the media arrangement 202. In one aspect, the second end cap 216 defines an opening 218 circumscribed by a seal member 220 defining an inwardly directed seal surface 220a. As most easily seen at FIG. 2, the seal surface 220a forms a seal against an outer surface 112a of the first outlet 112, which can be characterized as an outlet tube. With such an arrangement, the seal member 220 may be characterized as an inwardly directed radial seal member. Other arrangements are possible, for example, the seal member 220 may be provided with an outwardly directed radial seal surface that forms against an outlet tube circumscribing the seal member 220. With the disclosed configuration, all air entering inlet 110 is forced to pass through the media arrangement 202 before the air can be passed to the outlets 112, 114 via the interior volume 207.

The end caps 210, 216 typically comprise a soft compressible material formed from foamed resin, such as a foamed polyurethane. Commercially available foaming polyurethane can be used for the end cap molded-in-place materials. A detailed description of usable polyurethane can be found in such prior art as WO 2006/026241, incorporated herein by reference. Other materials are possible.

The media pack can comprise only media or the media can be provided with an inner and/or outer liner before installation in the cartridge 200. In some examples, an inner and/or outer liner is molded into the end caps 210, 216 along with the ends of the media arrangement 202.

As indicated previously, the filter cartridge 200 can be provided with an outlet arrangement 214 extending through the end wall 212 of the first end cap 210. The outlet arrangement 214 can be formed integrally with the end cap 210 or can be separately formed and then inserted through the end wall 212 via the aperture 212a. The outlet arrangement 214 is also shown as extending through the housing 102 at an aperture 114. In some examples, a seal member 115 can be provided at the aperture 114 to minimize the infiltration of moisture and debris into the housing 102. The outlet arrangement 214 can be directly or indirectly connected to a line 18 extending to the compressed air system 16. For example, the outlet arrangement 214 can be connected to the line via an in-line connector which connects to the outlet arrangement 214 with a push-push type of action. The outlet arrangement 214 could also be connected directly to the line 18 via a clamping system. The outlet arrangement 214 could also be received into a structure provided on the housing 102 which is in turn coupled to the line 18.

In one aspect, the outlet arrangement 214 includes a main body 222 and a valve assembly 224. The main body 222 provides a passageway between the interior volume 207 of the filter cartridge 200 and the exterior of the filter cartridge 200. The valve assembly 224, in fluid communication with the main body 222, operates to ensure that air can only flow in one direction through the main body 222. This functionality ensures that clean air can flow to the auxiliary system 16 during normal operation, but will block flow in the reverse direction. In a failure mode, where a leak or break occurs somewhere between the outlet arrangement 214 and the auxiliary system 16, the filter cartridge clean side (i.e. the interior volume 207) is exposed to untreated ambient air via the leak or break. The presence of the valve assembly 224 ensures that this untreated ambient air is prevented from entering the filter cartridge clean side via the main body 222. Were a valve assembly 224 not installed, a volume of untreated ambient air could undesirably bypass the filter media 202 through the outlet arrangement 214 and reach the internal combustion engine 14 via outlet 112.

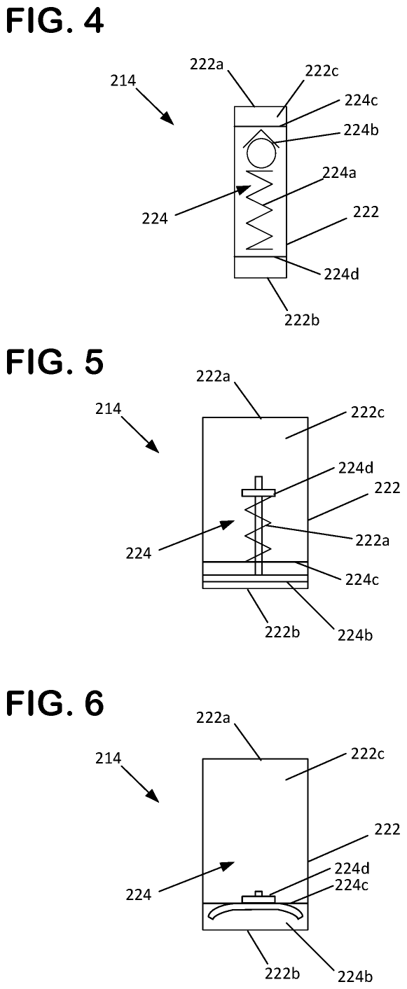

FIGS. 4 to 6 show examples of the outlet arrangement 214. The embodiments of FIGS. 4 and 5 both rely upon a biasing member, but are configured slightly differently and are oppositely acting. The embodiment of FIG. 6 utilizes a deflectable flap instead of a biasing member. As shown in FIGS. 4 and 5, the main body 222 extends from an inlet end 222a to an outlet end 222b and is hollow to define an interior passageway 222c. The inlet end 222a extends into, or is at least in fluid communication with, the interior 207 of the filter cartridge 200. Accordingly, clean air filtered by the cartridge 200 will flow into the inlet end 222a of the main body 222, through the interior passageway 222c, and out of the outlet end 222b, whereby clean air can be delivered to the auxiliary system 16. In general, the dimension of the interior passageway 222c provided by the main body 222 is smaller than the dimension of the opening 218 in the second end cap 216. For example, the interior passageway 222c can have a diameter that is less than half the diameter of the opening 218, less than a quarter of the diameter of the opening 218, less than an sixth of the diameter of the opening 218, and/or less than an eighth of the opening 218. Ultimately, the relative sizes of the passageway 222c and opening 218 are a function of the airflow needs of the internal combustion engine 14 and the auxiliary system 16, among other considerations.

In the examples shown at FIGS. 4 and 5, the valve assembly 224 is positioned within the interior passageway 222c of the main body 222 and is configured as a biased check valve. In the exemplary embodiment depicted at FIGS. 4 and 5, the valve assembly 224 can generally include a biasing member 224a, a stop member 224b, a seat 224c, and an end structure 224d. The seat 224c and end structure 224d are configured with apertures or openings (i.e. formed as a grid structure, annular ring, or the like) such that airflow can pass through them. The biasing member 224a can be a helical spring made of spring steel. In operation, the biasing member 224a acts against the end structure 224d and the stop member 224b such that a seal is formed between the stop member 224b and the seat 224c. Accordingly, any air flow in the direction from the end 222b towards the end 222a will be automatically blocked by the valve assembly 224. However, with a sufficient pressure differential in the opposite direction, air flow from the end 222a to the end 222b will be allowed as the biasing force of the biasing member 224a is overcome by the air flow pressure differential. The valve assembly 224 can also be provided with a stop member with a deflectable flap or flange member that deflects to allow airflow in one direction but seats against the seat 224c to prevent airflow in the opposite direction, thereby eliminating the need for a separate biasing member.

With reference to FIG. 6, a valve assembly 224 is provided that does not include a biasing member. Rather, the stop member 224b is shaped as a disk and is deflectable relative to the seat 224c. With such an arrangement, the valve assembly 224 is immobile with the exception of the deflectable stop member 224b. When air is flowing in the first direction towards the outlet end 222b, the stop member 224b will deflect in the direction of airflow (i.e. in a direction towards end 222b) to allow air to flow through the passageway 222c from the end 222a to the end 222b. However, when a pressure differential exists in the opposite direction, the seat 224c prevents the stop member 224b from deflecting towards the end 222a and forms a seal with the stop member 224b to prevent flow into the interior volume 207. FIG. 6 shows the valve assembly 224 with a portion of the stop member 224b deflected to allow airflow to pass through the valve assembly 224.

Further arrangements and configurations are possible. For example, the valve assembly 224 could be connected to one of the ends 222a, 222b of the main body 222, to the end cap 210 of the filter cartridge, or to the housing 102. Also, the valve assembly 224 could be configured as a different type of valve, such as a solenoid valve that is actuated under predetermined conditions (e.g. pressure drop, reverse flow detected, etc.).

### Media Types and Configurations

Any type of filter media can be used as the media pack for the filter cartridge 200 in accordance with embodiments of the invention. For example, woven and non-woven materials using natural and/or synthetic fibers can be used to form pleated media, fluted filter media, and depth media.

An exemplary configuration includes a filter cartridge with pleated media. An example of pleated media and end cap types usable with the air filter cartridge 200 disclosed herein is fully shown and described in U.S. Pat. No. 8,864,866, issued on Oct. 21, 2014, the entirety of which is incorporated by reference herein. The media can be configured in a cylindrical pattern as shown, if desired, although alternatives are possible. For example, the media can be somewhat conical in extension between the opposite ends. Also, the media can be configured with non-circular inner and/or outer perimeters; for example oval or other cross-sectional configurations are possible. When the media is pleated, the outer perimeter comprises outer pleat tips and inner perimeter comprises inner pleat tips. The media may include corrugations extending generally perpendicularly to the pleat tips, to facilitate keeping the pleats open during use. Various pleat tip folding techniques can be used to facilitate this, as are common in the art. Examples of this can be found in media packs the mark “PleatLoc” from Donaldson Company, Inc., of Minneapolis, Minn., the Assignee of the present disclosure. The media can also include hot melt media tip spacers or other media spacers if desired.

An exemplary configuration includes fluted filter media, such as a z-filter construction. The term “z- filter construction” as used herein, is meant to refer to a type of filter construction in which individual ones of corrugated, folded or otherwise formed filter flutes are used to define sets of longitudinal, typically parallel, inlet and outlet filter flutes for fluid flow through the media; the fluid flowing along the length of the flutes between opposite inlet and outlet flow ends (or flow faces) of the media. Some examples of filter media are provided in U.S. Pat. Nos. 5,820,646; 5,772,883; 5,902,364; 5,792,247; 5,895,574; 6,210,469; 6,190,432; 6,350,296; 6,179,890; 6,235,195; D399,944; D428,128; D396,098; D398,046; and D437,401, each of which is incorporated herein by reference.

It is noted that a plurality of embodiments are depicted and described. The embodiments are not meant to be exclusive with respect to features depicted. That is, selected features of one embodiment can be applied in one or more of the other embodiments if desired, to advantage. In many examples, the filter assembly depicted is an air cleaner assembly, for example, used to filter intake air for an internal combustion engine. Additional applications are possible, for example, applications in which the filter assembly is a crankcase ventilation filter assembly, in which the filter cartridge is used to filter crankcase blowby gases which include, typically, both particulate and liquid contaminant therein. Both type of filter assemblies are generally “gas filter assemblies,” since the carrier stage being filtered is gas (air or crankcase ventilation gases). While the techniques described herein will typically be used in application for gas filtration, they can be used in the filtration of other materials, for example, liquids, if desired.

The present invention has now been described with reference to several embodiments thereof. The entire disclosure of any patent or patent application identified herein is hereby incorporated by reference. The foregoing detailed description and examples have been given for clarity of understanding only. No unnecessary limitations are to be understood therefrom. It will be apparent to those skilled in the art that many changes can be made in the embodiments described without departing from the scope of the invention. Thus, the scope of the present invention should not be limited to the structures described herein, but only by the structures described by the language of the claims and the equivalents of those structures.

1. An air filter cartridge comprising:
a) a media arrangement defining an outer perimeter and an interior volume, and extending between a first end and a second end;
b) a first end cap located proximate the media arrangement first end, the first end cap defining a first opening;
c) a second end cap located proximate the media arrangement second end, the second end cap defining a second opening generally circumscribed by a seal member, wherein the first opening has a dimension that is less than half a corresponding dimension of the second opening; and
d) a valve arrangement in fluid communication with the first opening, the valve arrangement allowing airflow through the first opening in a first direction from the interior volume to the exterior side and prevents airflow through the first opening in a second direction from the exterior side into the interior volume.

2. The air filter cartridge of claim 1, wherein:
a) the valve arrangement is a check valve biased into a closed position.

3. The air filter cartridge of claim 1, wherein:
a) the valve arrangement includes a deflectable stop member that deflects to allow airflow to flow in the first direction.

4. The air filter cartridge of claim 1, wherein:
a) the valve arrangement is in fluid communication with an internal passageway of a main body extending through the first opening.

5. The air filter cartridge of claim 4, wherein:
a) the valve arrangement is disposed within the internal passageway.

6. The air filter cartridge of claim 1, wherein:
a) the media arrangement includes pleated media.

7. An air cleaner comprising:
a) a housing defining an interior cavity, the housing having an inlet, a first outlet, and a second outlet; and
b) a filter cartridge comprising:
i. a media arrangement defining an outer perimeter and an interior volume, and extending between a first end and a second end, the outer perimeter being in direct fluid communication with the housing inlet;
ii. a first end cap located proximate the media arrangement first end, the first end cap defining a first opening in fluid communication with the housing first outlet;
iii. a second end cap located proximate the media arrangement second end, the second end cap defining a second opening generally circumscribed by a seal member forming a seal with the second outlet, wherein the first opening has a dimension that is less than half a corresponding dimension of the second opening; and
iv. a valve arrangement in fluid communication with the first opening and the housing first outlet, the valve arrangement allowing airflow through the first opening in a first direction from the interior volume to the exterior side and prevents airflow through the first opening in a second direction from the exterior side into the interior volume.

8. The air cleaner of claim 7, wherein:
a) the valve arrangement is a check valve biased into a closed position.

9. The air cleaner of claim 7, wherein:
a) the valve arrangement includes a deflectable stop member that deflects to allow airflow to flow in the first direction.

10. The air cleaner of claim 8, wherein:
a) the valve arrangement is in fluid communication with an internal passageway of a main body extending through the first opening.

11. The air cleaner of claim 10, wherein:
a) the valve arrangement is disposed within the internal passageway.

12. The air cleaner of claim 7, wherein:
a) the media arrangement includes pleated media.

13. The air cleaner of claim 10, wherein the main body extends through the housing first outlet.

14. An air cleaner comprising:
a) a housing defining an interior cavity, the housing having an inlet, a first outlet, and a second outlet;
b) a filter cartridge comprising:
i. a media arrangement defining an outer perimeter and an interior volume, and extending between a first end and a second end, the outer perimeter being in direct fluid communication with the housing inlet;
ii. a first end cap located proximate the media arrangement first end, the first end cap defining a first opening in fluid communication with the housing first outlet;
iii. a second end cap located proximate the media arrangement second end, the second end cap defining a second opening generally circumscribed by a seal member forming a seal with the second outlet, wherein the first opening has a dimension that is less than half a corresponding dimension of the second opening; and
c) a valve arrangement in fluid communication with the first opening and the housing first outlet, the valve arrangement allowing airflow through the first opening and housing first outlet in a first direction from the interior volume to the exterior side and prevents airflow through the first opening in a second direction from the exterior side into the interior volume.

15. The air cleaner of claim 14, wherein:
a) the valve arrangement is a check valve biased into a closed position.

16. The air cleaner of claim 14, wherein:
a) the valve arrangement includes a deflectable stop member that deflects to allow airflow to flow in the first direction.

17. The air cleaner of claim 15, wherein:
a) the valve arrangement is in fluid communication with an internal passageway of a main body extending through the first opening.

18. The air cleaner of claim 17, wherein:
a) the valve arrangement is disposed within the internal passageway.

19. The air cleaner of claim 14, wherein:
a) the media arrangement includes pleated media.

20. The air cleaner of claim 17, wherein the main body extends through the housing first outlet.
